(19) United States
(12) Patent Application Publication
(10) Pub. No.: US 2019/0342956 A1
(43) Pub. Date: Nov. 7, 2019

(54) OPTOELECTRONIC CIRCUIT COMPRISING LIGHT EMITTING DIODES

(71) Applicant: Aledia, Grenoble (FR)

(72) Inventors: Frédéric Mercier, Saint Nicolas De Macherin (FR); Yves Salmon, Crolles (FR)

(73) Assignee: Aledia, Grenoble (FR)

(21) Appl. No.: 16/066,622

(22) PCT Filed: Dec. 28, 2016
(86) PCT No.: PCT/FR2016/053675

§ 371 Date: Jun. 27, 2018

(30) Foreign Application Priority Data
Dec. 29, 2015 (FR) 1563433

(51) Int. Cl. H05B 33/08

(52) U.S. Cl. CPC H05B 33/083

(57) ABSTRACT

An optoelectronic circuit including series-connected sets of light emitting diodes and a module for controlling said sets, the sets of light emitting diodes being arranged on a support and being distributed among a series of aligned basic circuits which are located on the support and each of which includes at least one light emitting diode from each set.

The present patent application claims the priority benefit of French patent application FR15/63433 which is herein incorporated by reference.

### BACKGROUND

The present description relates to an optoelectronic circuit, particularly to an optoelectronic circuit comprising light-emitting diodes.

### DISCUSSION OF THE RELATED ART

For certain applications, it is known to successively activate assemblies of light-emitting diodes of an optoelectronic circuit. An example concerns the power supply of an optoelectronic circuit comprising light-emitting diodes with an AC voltage, particularly a sinusoidal voltage, for example, the mains voltage.

FIG. 1 shows an example of an optoelectronic circuit 10 comprising input terminals IN₁ and IN₂ having an AC voltage V_{IN} applied therebetween. Optoelectronic circuit 10 further comprises a rectifying circuit 12 comprising a diode bridge 14, receiving voltage V_{IN} and supplying a rectified voltage V_{ALIM} which powers N series assemblies of elementary light-emitting diodes, called general light-emitting diodes Dᵢ, where i is an integer in the range from 1 to N. The elementary light-emitting diodes of each general light-emitting diode Dᵢ are preferably series-connected.

Optoelectronic circuit 10 comprises a current source 22 having a terminal coupled to node A₂ and having its other terminal coupled to a node A₃. Circuit 10 comprises a device 24 for switching general light-emitting diodes Dᵢ, i being in the range from 1 to N. Switching device 24 enables to progressively increase the number of general light-emitting diodes receiving power supply voltage V_{ALIM} during a rising phase of power supply voltage V_{ALIM} and to progressively decrease the number of general light-emitting diodes receiving power supply voltage V_{ALIM} during a falling phase of power supply voltage V_{ALIM}. This enables to decrease the time during which no light is emitted by optoelectronic circuit 10. As an example, device 24 comprises N controllable switches SW₁ to SW_{N}. Each switch SWᵢ, with i varying from 1 to N, is assembled between node A₃ and the cathode of general light-emitting diode Dᵢ and is controlled by a control unit 26 according to signals supplied by a sensor 28.

The order in which switches SWᵢ are turned on and off is set by the structure of optoelectronic circuit 10 and is repeated for each cycle of power supply voltage V_{ALIM}.

FIG. 2 is a timing diagram of power supply voltage V_{ALIM} in the case where AC voltage V_{IN} corresponds to a sinusoidal voltage and for an example where optoelectronic circuit 10 comprises four light-emitting diodes D₁, D₂, D₃, and D₄. FIG. 2 schematically shows the respective emission phases P₁, P₂, P₃, and P₄ of general light-emitting diodes D₁, D₂, D₃, D₄. Thus, the conduction time of general light-emitting diode D₄ is much shorter than that of general light-emitting diode D₁.

A disadvantage of optoelectronic circuit 10 is that, according to the configuration of optoelectronic circuit 10, an observer may perceive an inhomogeneity of the light power emitted by optoelectronic circuit 10, particularly when the general light-emitting diodes are distant from one another.

FIG. 3 partially and schematically shows a top view of optoelectronic circuit 10 comprising an area 30 having general light-emitting diodes D₁ to D₄ formed therein and an area 32 having the other elements of the optoelectronic circuit 10 formed therein. As an example, general light-emitting diodes D₁ to D₄ are substantially aligned and arranged next to one another. In this example of layout, an observer may perceive, in particular when the general light-emitting diodes have large dimensions or are spaced apart, a light power emitted by area 30 of optoelectronic circuit 10 which is greater on the side of general light-emitting diode D₁, which has the longest light emission time, than on the side of general light-emitting diode D₄, which has the shorter light emission time.

### SUMMARY

An object of an embodiment is to overcome all or part of the disadvantages of the previously-described optoelectronic circuits comprising general light-emitting diodes and a device for switching the light-emitting diodes.

Another object of an embodiment is to improve the homogeneity of light emission by the optoelectronic circuit.

Another object of an embodiment is for the number of elementary light-emitting diodes of each general light-emitting diode of the optoelectronic circuit to be simply modifiable.

Thus, an embodiment provides an optoelectronic circuit comprising series-connected assemblies of light-emitting diodes and a module for controlling said assemblies, the assemblies of light-emitting diodes being arranged on a support and being distributed over a succession of aligned elementary circuits located on the support, each elementary circuit comprising at least one light-emitting diode of each assembly.

According to an embodiment, each assembly comprises groups, assembled in parallel, of light-emitting diodes.

According to an embodiment, for each assembly, each elementary circuit comprises the light-emitting diodes of at least one of the groups of said assembly.

According to an embodiment, each elementary circuit is divided into circuit segments, and, for each group, the light-emitting diodes of said group are distributed over all the circuit segments.

According to an embodiment, the circuit segments are aligned. According to an embodiment, each elementary circuit further comprises a current-limiting circuit.

According to an embodiment, the current-limiting circuits are assembled in parallel. According to an embodiment, each current-limiting circuit comprises a resistor. According to an embodiment, the optoelectronic circuit comprises at least in aligned fashion on the support, successively:

the control module; and

said assemblies of light-emitting diodes distributed over said succession of elementary circuits.

According to an embodiment, the optoelectronic circuit further comprises:

an additional control module; and

additional assemblies of light-emitting diodes distributed over an additional succession of elementary circuits located on successive aligned portions of the support, each elementary circuit of the additional succession comprising at least one light-emitting diode of each additional assembly.

Another embodiment provides a method of manufacturing the optoelectronic circuit comprising the steps of:

manufacturing an initial optoelectronic circuit comprising the series-connected assemblies of light-emitting diodes and the module for controlling said assemblies, and further comprising additional assemblies of light-emitting diodes distributed over an additional succession of aligned elementary circuits located on the support, each elementary circuit of the additional succession comprising at least one light-emitting diode of each additional assembly; and

cutting the initial optoelectronic circuit to remove the additional assemblies.

### BRIEF DESCRIPTION OF THE DRAWINGS

The foregoing and other features and advantages will be discussed in detail in the following non-limiting description of specific embodiments in connection with the accompanying drawings, among which:

FIG. 1, previously described, is an electric diagram of an example of an optoelectronic circuit comprising light-emitting diodes;

FIG. 2, previously described, is a timing diagram showing the light emission phases of the light-emitting diodes of the optoelectronic circuit of FIG. 1;

FIG. 3, previously described, is a partial simplified top view of an example of a layout of the elements of the optoelectronic circuit of FIG. 1;

FIG. 4 is an electric diagram of an embodiment of an optoelectronic circuit comprising light-emitting diodes;

FIG. 5 illustrates a step of an embodiment of a method of manufacturing the optoelectronic circuit of FIG. 4; and

FIGS. 6 and 7 are electric diagrams of embodiments of a portion of the optoelectronic circuit of FIG. 4.

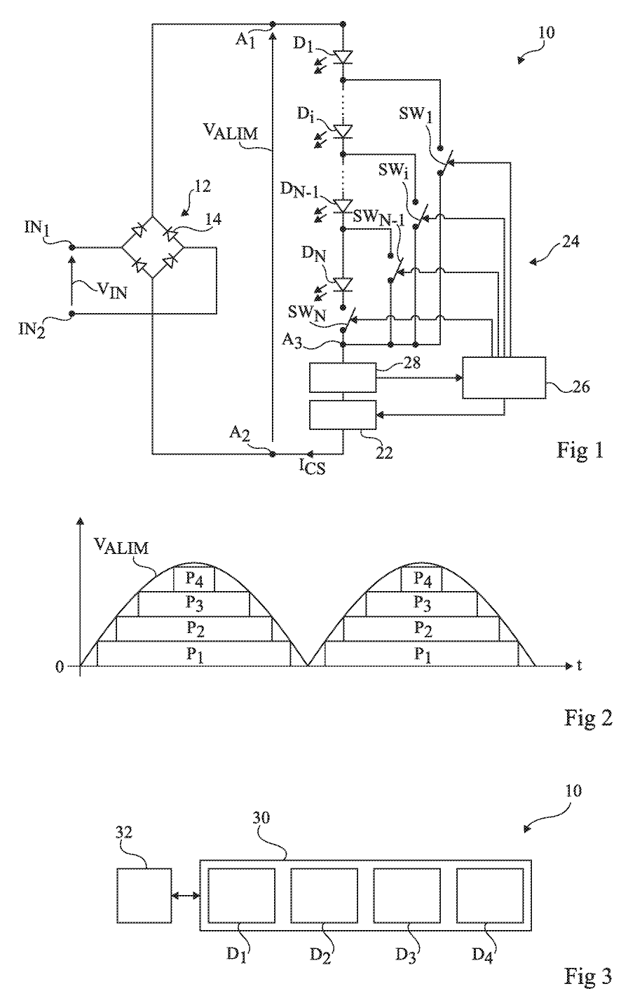

### DETAILED DESCRIPTION

For clarity, the same elements have been designated with the same reference numerals in the various drawings and, further, the various drawings are not to scale. The terms “approximately”, “substantially”, and “in the order of” are used herein to designate a tolerance of plus or minus 10% of the value in question. Further, in the present description, term “connected” is used to designate a direct electric connection, with no intermediate electronic component, for example, by means of a conductive track, and term “coupled” or term “linked” will be used to designate either a direct electric connection (then meaning “connected”) or a connection via one or a plurality of intermediate components (resistor, capacitor, etc.).

According to an embodiment, the general light-emitting diodes are formed in modular fashion and are distributed according to a plurality of light-emitting diode modules, called optical modules or optical circuits hereafter, coupled to one another. According to an embodiment, the elementary light-emitting diodes of each general light-emitting diode are distributed on each optical module. According to an embodiment, the optical modules all have the same structure. This advantageously enables to easily add an optical module to the optoelectronic circuit or to easily remove an optical module from the optoelectronic circuit.

The elementary light-emitting diodes are, for example, planar light-emitting diodes, each comprising a stack of layers laid on a planar surface, having at least one active layer capable of emitting light. The elementary light-emitting diodes are, for example, light-emitting diodes formed from three-dimensional semiconductor elements, particularly microwires, nanowires, or pyramids, for example comprising a semiconductor material based on a compound mainly comprising at least one group-III element and one group-V element (for example, gallium nitride GaN), called III-V compound hereafter, or mainly comprising at least one group-II element and one group-VI element (for example, zinc oxide ZnO), called II-VI compound hereafter. Each three-dimensional semiconductor element is covered with at least one active layer capable of emitting light.

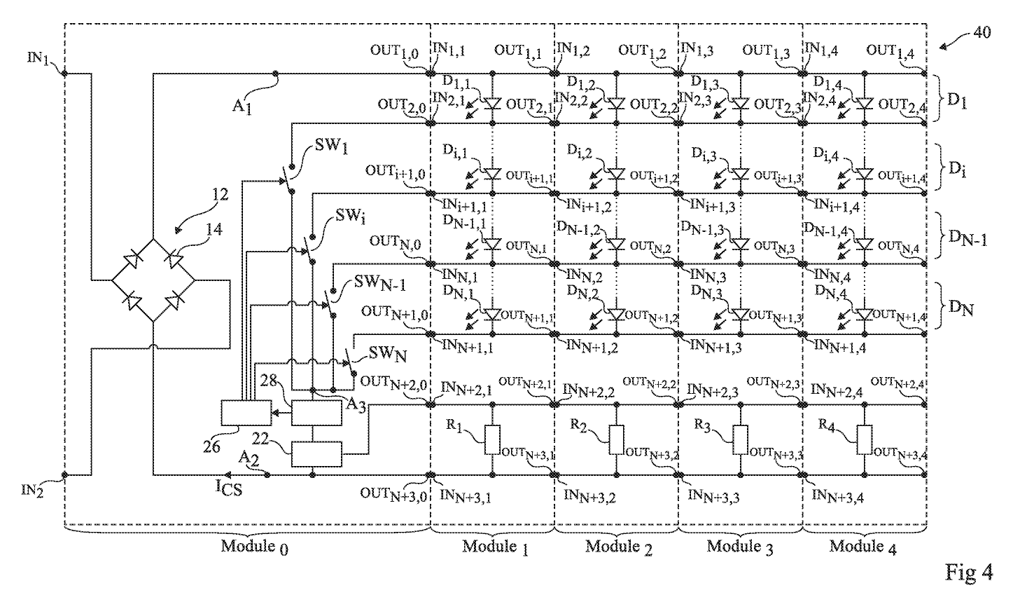

FIG. 4 shows an embodiment of an optoelectronic circuit 40. The elements common with optoelectronic circuit 10 are designated with the same references. In particular, optoelectronic circuit 40 comprises rectifying circuit 12, current source 22, control unit 26, sensor 28, and switches SW₁ to SW_{N}, which are distributed in a module₀, called control module hereafter. The elementary light-emitting diodes which form each general light-emitting diode Dᵢ, with i varying from 1 to N, are distributed over K optical modules, K being an integer greater than or equal to 2, for example, in the range from 2 to 100. FIG. 4 shows four optical modules Module₁, Module₂, Module₃ and Module₄. More specifically, the elementary light-emitting diodes of each general light-emitting diode Dᵢ are distributed in K groups D_{i,j} of elementary light-emitting diodes, j being an integer in the range from 1 to K, each group D_{i,j} belonging to optical module Moduleⱼ. According to an embodiment, groups D_{i,j}, with j varying from 1 to K, are assembled in parallel for each general light-emitting diode Dᵢ. According to an embodiment, the elementary light-emitting diodes of each group D_{i,j} are series assembled.

Each optical module Moduleⱼ comprises input nodes IN_{i,j} and output nodes OUT_{i,j} where i is an integer in the range from 1 to N+3 in the present embodiment, for example, from 4 to 103. Preferably, optical modules Moduleⱼ all have the same number of input nodes and, for each optical module Moduleⱼ, the number of input nodes IN_{i,j} is equal to the number of output nodes OUT_{i,j}. Nodes IN_{i,j} and OUT_{i,j} are connected to the anode of group D_{i,j}, for i varying from 1 to N. Nodes IN_{N+1,j} and OUT_{N+1,j} are connected to the cathode of group D_{N}. Control module Module₀ further comprises output nodes OUT_{i,0}, with i varying from 1 to N+3 in the present embodiment. Output node OUT_{1,0} is connected to node A₁ and output node OUT_{N+3,0} is connected to node A₂.

According to an embodiment, optical modules Module₁ to Module_{K} are identical. The modules are successively connected to one another. The input nodes IN_{i,1} of the first optical module Moduleⱼ in the succession of optical modules are connected to the output nodes OUT_{i,0} of control module Module₀ and the output nodes OUT_{i,j} of each optical module Moduleⱼ, with j varying from 1 to K, are connected to the input nodes IN_{i,j+1} of the next optical module Moduleⱼ₊₁. The addition of an additional optical module to the succession of optical modules may advantageously be performed in simple fashion.

Since the elementary light-emitting diodes of each general light-emitting diode Dᵢ are distributed over each module Moduleⱼ, adding an additional optical module to optoelectronic circuit 40 causes the addition of elementary light-emitting diodes to each general light-emitting diode Dᵢ. During a cycle of variation of power supply voltage V_{ALIM,} when a general light-emitting diode becomes conductive, this corresponds to the emission of light of all the elementary light-emitting diodes of the general light-emitting diode and thus of elementary light-emitting diodes belonging to the additional optical module. The light emission of each general light-emitting diode is thus distributed over each optical module.

According to an embodiment, each module Moduleⱼ further comprises a current-limiting circuit Rⱼ. As an example, circuit Rⱼ may correspond to a resistor. According to an embodiment, nodes IN_{N+2,j} and OUT_{N+2,j} are connected to a terminal of current-limiting circuit Rⱼ and nodes IN_{N+3,j} and OUT_{N+3,j} are connected to the other terminal of current-limiting circuit Rⱼ. Current-limiting circuits R₁ to R_{K} are then assembled in parallel. According to an embodiment, current source 22 may be of resistive nature. In this case, resistors R₁ to R_{K} may play the role of the current source and be connected in parallel between nodes A₂ and A₃. According to an embodiment, current source 22 is an active current source, particularly comprising metal-oxide field-effect transistors or MOS transistors. The voltage across resistors R₁ to R_{K} assembled in parallel may be used by current source 22 to adapt the intensity of current I_{CS}. When an additional optical module is added, the resistor of the additional optical module is assembled in parallel across the resistors of the other optical modules. This may cause a modification of the intensity of current I_{CS} to take into account the presence of the additional optical module.

According to an embodiment, each module Module₀ to Module₁ corresponds to a different integrated circuit chip, the integrated circuit chips being assembled on a printed circuit to be coupled to one another. According to an embodiment, a plurality of optical modules are formed on a same integrated circuit chip. According to another embodiment, modules Module₀ to Module₁ are formed on a same integrated circuit chip. The modules are preferably aligned to form a band of modules.

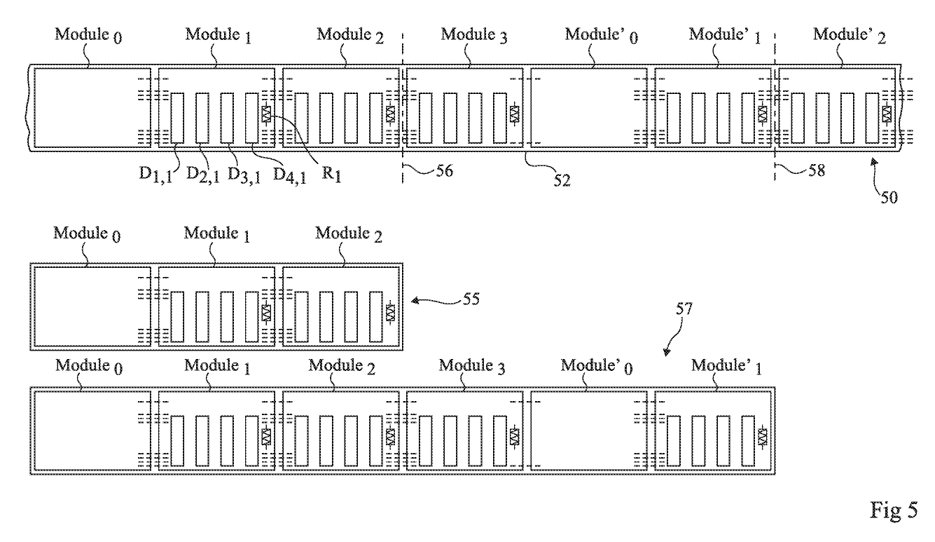

FIG. 5 illustrates an embodiment of a method of manufacturing an optoelectronic circuit similar to optoelectronic circuit 40.

In this embodiment, a first optoelectronic circuit 50 is formed on a support 52 and comprises series of successive optical modules separated by a control module. The optical modules and the control modules may have the structure previously described in relation with FIG. 4. The series of optical modules may comprise the same number of optical modules or comprise different numbers of optical modules.

As an example, at the top of FIG. 5, optoelectronic circuit 50 successively comprises, from left to right, a control module Module₀, three successive optical modules Module₁, Module₂, Module₃, a control module Module′₀, and two successive optical modules Module′₁ and Module′₂. FIG. 5 schematically shows, for each module, the groups of elementary light-emitting diodes D_{i,j} with rectangles, resistors Rⱼ with a hatched rectangle, and the connection between modules with horizontal lines in dotted lines.

The frequency of repetition of control modules Module₀ depends on the maximum power admissible by the switches of control module Module₀. According to an embodiment, when a control module Module₀ is located between two optical modules, the input nodes IN₁ and IN₂ of this control module are respectively connected to output nodes OUT_{1,K} and OUT_{N+3,K} of the previous optical module.

According to an embodiment, the control modules Module₀ have the same structure, which may be that shown in FIG. 4. According to another embodiment, only one of control modules Module₀ comprises rectifying circuit 12, while the other control modules Module′₀ do not comprise rectifying circuit 12 and have their input node IN₁ directly connected to node A₁ and their input node IN₂ directly connected to node A₂. According to another embodiment, none of control modules Module₀ comprises rectifying circuit 12, the rectifying circuit being provided on a different circuit if its use is necessary according to the envisaged application.

Optoelectronic circuits may be manufactured from optoelectronic circuit 50 by cutting of optoelectronic circuit 50. As an example, optoelectronic circuit 55 shown in the middle of FIG. 5 may be obtained by cutting optoelectronic circuit 50 at the level of vertical line 56 and optoelectronic 57 shown at the bottom of FIG. 5 may be obtained by cutting the optoelectronic circuit at the level of vertical line 58.

Advantageously, the modules are arranged one after the other in the form of a band so that the cutting of optoelectronic circuit 50 is eased.

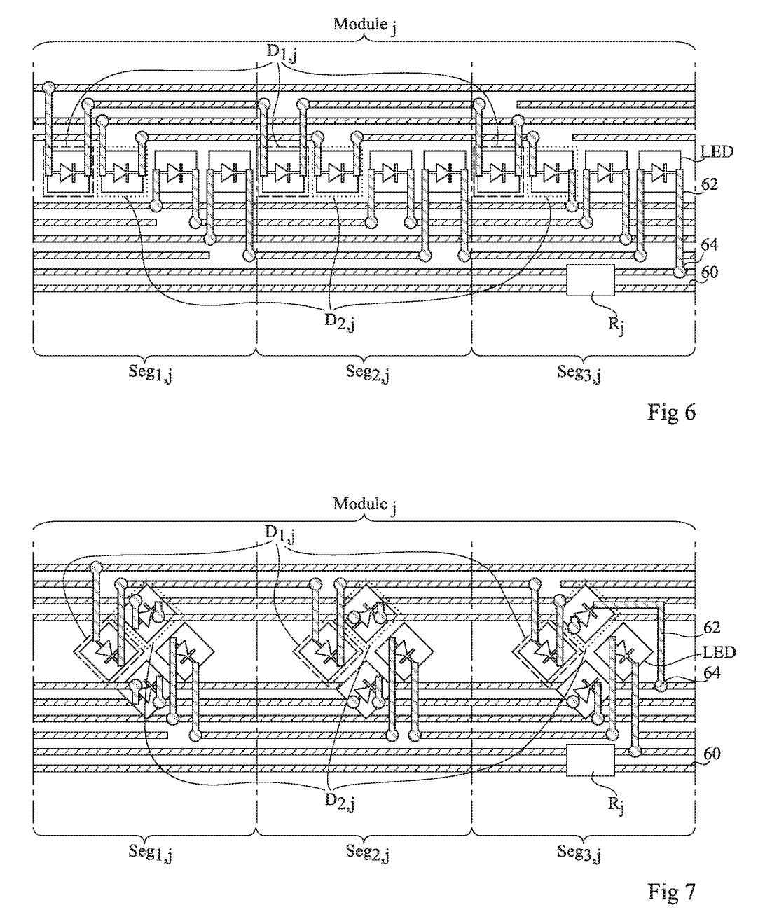

FIGS. 6 and 7 show embodiments of groups D_{1,j} to D_{N,j} of light-emitting diodes of an optical module Moduleⱼ. Each group of elementary light-emitting diodes D_{1,j} comprises a number M of elementary light-emitting diodes LED. For each module Moduleⱼ, the M*N elementary light-emitting diodes are distributed in an integral number P of segments Seg_{q,j}, where q is an integer in the range from 1 to P, each segment Seg_{q,j} comprising an elementary light-emitting diode from each group of elementary light-emitting diodes D_{1,j} to D_{N,j}.

FIGS. 6 and 7 schematically show each elementary light-emitting diode by a LED square containing the electric symbol of a light-emitting diode. Conductive tracks of a first metallization level have further been shown as bands 60 with simple hatchings and conductive tracks of a metallization level higher than the first level have been shown as bands 62 with double hatchings 0. Each vertical band 62 is continued by a circle 64 which corresponds to the connection (for example, a via) coupling conductive track 62 to one of conductive tracks 60. As an example, in FIGS. 6 and 7, each module Moduleⱼ comprises four groups D_{i,j}, and each group comprises three elementary light-emitting diodes, LED, distributed over three segments Seg _{1,j}, Seg_{2,j} and Seg_{3,j}. In FIGS. 6 and 7, the elementary light-emitting diodes, LED, of group D_{1,j} have been surrounded with a dashed line and the elementary light-emitting diodes, LED, of group D_{2,j}, have been surrounded with a dotted line.

According to an embodiment, the layout of the elementary light-emitting diodes, LED, is identical for each segment Seg_{q,j}. Each group D_{1,j} to D_{N,j} comprises at least one elementary light-emitting diode per segment Seg_{q,j}. According to an embodiment, the layout of the conductive tracks 60, 62 of intermediate segments Seg_{q,j} with q varying from 2 to P−1, is identical and the layout of the conductive tracks 60, 62 of the first segment Seg_{1,j} and of the last segment Seg_{P,j} is different from the layout of conductive tracks 60, 62 of the intermediate segments Seg_{2,j} to Seg_{P-1,j}.

In FIGS. 6 and 7, the elementary light-emitting diodes, LED, of each group D_{i,j} to D_{N,j} are series-assembled and groups D_{1,j} to D_{N,j} are series-assembled. In the embodiment shown in FIG. 6, the elementary light-emitting diodes, LED, are aligned. For each segment Seg_{l,j} to Seg_{3,j}, the first elementary light-emitting diode belongs to the first group D_{1,j}, the second elementary light-emitting diode belongs to the second group D_{2,j}, and so on. In the embodiment shown in FIG. 7, for each segment Seg_{1,j} to Seg_{3,j}, the elementary light-emitting diodes, LED, are arranged at the corners of a square, the elementary light-emitting diode located at the same corner for each segment belonging to the same group.

Specific embodiments have been described. Various alterations and modifications will occur to those skilled in the art. In particular, although in the previously-described embodiments, the elementary light-emitting diodes of each group are in series, the connection of these elementary light-emitting diodes may be different, for example, series-assembled pairs of elementary light-emitting diodes assembled in parallel.

1. An optoelectronic circuit comprising series-connected assemblies of light-emitting diodes and a module for controlling said assemblies, the assemblies of light-emitting diodes being arranged on a support and being distributed on a succession of aligned elementary circuits located on the support, each elementary circuit comprising at least one light-emitting diode of each assembly.

2. The optoelectronic circuit of claim 1, wherein each assembly comprises groups, connected in parallel, of light-emitting diodes.

3. The optoelectronic circuit of claim 2, wherein, for each assembly, each elementary circuit comprises the light-emitting diodes of at least one of the groups of said assembly.

4. The optoelectronic circuit of claim 3, wherein each elementary circuit is divided into circuit segments, and wherein, for each group, the light-emitting diodes of said group are distributed over all the circuit segments.

5. The optoelectronic circuit of claim 4, wherein the circuit segments are aligned.

6. The optoelectronic circuit of claim 1, wherein each elementary circuit further comprises a current-limiting circuit.

7. The optoelectronic circuit of claim 6, wherein the current-limiting circuits are connected in parallel.

8. The optoelectronic circuit of claim 6, wherein each current-limiting circuit comprises a resistor.

9. The optoelectronic circuit of claim 1, comprising at least in aligned fashion on the support, successively:
the control module; and
said assemblies of light-emitting diodes distributed over said succession of elementary circuits.

10. The optoelectronic circuit of claim 9, further comprising:
an additional control module; and
additional assemblies of light-emitting diodes distributed over an additional succession of elementary circuits located on successive aligned portions of the support, each elementary circuit of the additional succession comprising at least one light-emitting diode of each additional assembly.

11. A method of manufacturing the optoelectronic circuit of claim 1, comprising the steps of:
manufacturing an initial optoelectronic circuit comprising the series-connected assemblies of light-emitting diodes and the module for controlling said assemblies, and further comprising additional assemblies of light-emitting diodes distributed over an additional succession of aligned elementary circuits located on the support, each elementary circuit of the additional succession comprising at least one light-emitting diode of each additional assembly; and
cutting the initial optoelectronic circuit to remove the additional assemblies.
